(19) United States
(12) Patent Application Publication
(10) Pub. No.: US 2011/0233960 A1
(43) Pub. Date: Sep. 29, 2011

(54) AERODYNAMIC SKIRTS FOR TRUCK TRAILERS

(76) Inventor: Richard Heinz, Gladstone, MI (US)

(21) Appl. No.: 13/070,709

(22) Filed: Mar. 24, 2011

Related U.S. Application Data
(60) Provisional application No. 61/317,106, filed on Mar. 24, 2010.

(51) Int. Cl. B62D 35/00

(52) U.S. Cl. 296/180.4

(57) ABSTRACT

A skirt or fairing system is provided that is attachable to a lower, longitudinal edge of a trailer, such as a commercial freight trailer, in a manner that alters the airflow beneath and around the trailer to produce increased fuel efficiency and greater driving safety. The skirt fairing is formed from a deformable skin material stretched tautly over a deflectable frame is provided that is attachable to the lower edge of a trailer. The installation of the skirt fairing deflects and alters the airflow beneath the trailer by creating smooth and cohesive airflow along the side and underneath the trailer of a tractor trailer rig in a manner that improves safety and decreases fuel consumption. Further, the fairing is formed using a deformable skin and deflectable frame that prevents damage or permanent displacement of the fairing should it impact an obstruction.

### CROSS-REFERENCE TO RELATED APPLICATIONS

This application is related to and claims priority from earlier filed U.S. Provisional Patent Application No. 61/317,106, filed Mar. 24, 2010, the contents of which are incorporated herein by reference.

### BACKGROUND OF THE INVENTION

The present invention relates generally to a skirt or fairing system that is attachable to a vehicle. More specifically, the present invention relates to a skirt of fairing system for attachment to a lower, longitudinal edge of a trailer, such as a commercial freight trailer, in a manner that alters the airflow beneath and around the trailer to produce increased fuel efficiency and greater driving safety.

In the automotive industry, a great deal of energy is expended on the design of modern cars to insure that they are aerodynamically efficient. While this has allowed an improvement in the overall handling and fuel efficiency of these vehicles, limited progress in the area of aerodynamic design has been made with heavy-duty commercial vehicles, over the road trucks and the like. The lack of progress in this area is particularly unfortunate because the fuel consumption by large commercial vehicles is very high by comparison and any improvement in their aerodynamic performance is of great significance in improving fuel economy.

Even as fuel costs continue to increase, the transportation of freight by highway trucks has been increasing in volume for several years, and it appears that it will continue to increase in the future. However, as stated above, little effort has been dedicated to the aerodynamic design of these large trucks, leaving the problem of reduction in the energy needed to overcome wind resistance largely unaddressed. While it is known that through aerodynamic design and streamlining vehicles can accomplish great savings in fuel expenses, little attention has been directed to the trailer that is towed by large tractor trucks. Large commercial trucks, and particularly tractor-trailer rigs, having multiple rear wheels that present a high resistance to air flow. Further, the rear wheel suspension and the other mechanical components at the rear of the vehicle interfere with the smooth flow of air around and under the vehicle, resulting in eddy currents that add to the overall rolling wind resistance of the vehicle. This interference creates turbulence and a high aerodynamic drag that, in turn, results in increased fuel consumption and a high cost of operation. Furthermore, the turbulent flow can affect the trailers ability to track behind the truck. This reduced driving stability is most prevalent in high crosswind conditions or when the trailer is empty. Furthermore, the turbulent flow creates a hazard for the drivers of other vehicles when it is raining or snowing because any water splashed up from the roadway by the trailer tires is thrown outwardly by the turbulent air flow striking the windshields of adjacent vehicles thereby lowering their visibility.

As a result of the issues described above, it is necessary to improve the aerodynamics of a tractor trailer rig in order to improve its performance, particularly acceleration, top speed, fuel economy, tracking stability and tire wear. One such improvement consists of skirts that close the trailer body sides down toward the ground to reduce the turbulent airflow therebeneath that creates the drag. Such skirts demonstrate a drag coefficient reduction of up to 0.06 per trailer on a tractor-trailer combination or about 0.02 on a straight truck. The use of such skirts has proven to reduce the fuel consumption of these trucks by nearly 6%. The skirts operate to provide a smooth transition surface along the sides of the trailer from between the rear wheels of the tractor and the rear wheels of the trailer. The skirts or fairings streamline airflow past the void space between the tractor and trailer by eliminating turbulence and decreasing drag on the truck.

Often these skirts however are formed from relatively rigid polymer or rubber sheets. Still further, other skirts are formed from sheet metal or employ rigid framework for their support. The prior construction methods are problematic in that they are generally costly to manufacture and install. Further, such skirts are susceptible to damage due to the fact that when turning large tractor trailer rigs, the sides of the trailers pass over curbs and snow drifts in a manner that breaks, bends or cracks the typical prior art skirt systems. Such damage then results in the need for costly repairs and often if unrepaired result in the reintroduction of aerodynamic drag and the loss of the benefits that the skirts were installed to provide.

In view of the above-described shortcomings with the current state of the art in trail skirt assemblies, there is a need for a trailer skirt that is flexible and resilient such that when the skirt impacts another object or obstruction the skirt will temporarily deform and then return to its original deployed position. Still further there is a need for a trailer skirt system that is formed using a flexible, inexpensive skin panel that is stretched taught over a resilient frame such that when the skirt impacts another object or obstruction the skirt will temporarily deform and then return to its original deployed position with little or no damage to the system. If the system is damaged beyond repair the new skin cost will be much less expensive than other systems.

### BRIEF SUMMARY OF THE INVENTION

In this regard, the present invention provides for a skirt or fairing system that is attachable to a lower, longitudinal edge of a trailer, such as a commercial freight trailer, in a manner that alters the airflow beneath and around the trailer to produce increased fuel efficiency and greater driving safety. Generally, in accordance with the present invention, a skirt fairing formed from a deformable skin material stretched tautly over a deflectable frame is provided that is attachable to the lower edge of a trailer. The installation of the skirt fairing deflects and alters the airflow beneath the trailer by creating smooth and cohesive airflow along the side and underneath the trailer of a tractor trailer rig in a manner that improves safety and decreases fuel consumption. Further, the fairing of the present invention is formed using a deformable skin and deflectable frame that prevents damage or permanent displacement of the fairing should it impact an obstruction.

Most generally the skirt fairing of the present invention includes a perimeter frame structure and a skin material stretched over the perimeter frame. In the simplest embodiment the frame includes forward and rearward vertical rails that are affixed at the front and rear of the region to be covered along the longitudinal edge of the trailer. The vertical rails are affixed using a hinge or spring that allows for temporary deformation of the rails when they come upon an obstruction, yet return to their original position without damage. A deformable skin is then stretched tautly between the two vertical rails. To further enhance the functionality and durability of the skirt fairing, a bottom frame member may be provided that extends between the lower ends of the forward and rearward vertical rails. The bottom frame member may be joined or flexible tubing, a cable, rope, nylon webbing or a chain. In operation, the vertical rails will be biased such that the lower ends of the vertical rails in an unrestrained state will flair apart from one another such that when the lower rail is installed the bias serves to tension the lower rail. The bottom edge of the in this arrangement would then be affixed to or about the lower frame member as well.

It is therefore an object of the present invention to provide a trailer skirt that is flexible and resilient such that when the skirt impacts another object or obstruction the skirt will temporarily deform and then return to its original deployed position. It is a further object of the present invention to provide a trailer skirt system that is formed using a flexible, inexpensive skin panel that is stretched taught over a resilient frame such that when the skirt impacts another object or obstruction the skirt will temporarily deform and then return to its original deployed position with little or no damage to the system.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a side view of the fairing system of the present invention attached to a lower, longitudinal edge of a commercial freight trailer;

FIG. 2 is a side view of the fairing system of the present invention;

FIG. 3 is a one of the vertical supports for the fairing system of the present invention;

FIG. 4 is a cross sectional view taken along line 4-4 in FIG. 3;

FIG. 5 is a second of the vertical supports for the fairing system of the present invention;

FIG. 6 is an additional fairing skirt to be used in connection with the fairing system of the present invention; and

FIG. 7 depicts an alternate embodiment support for the additional fairing skirt of FIG. 6.

### DETAILED DESCRIPTION OF THE INVENTION

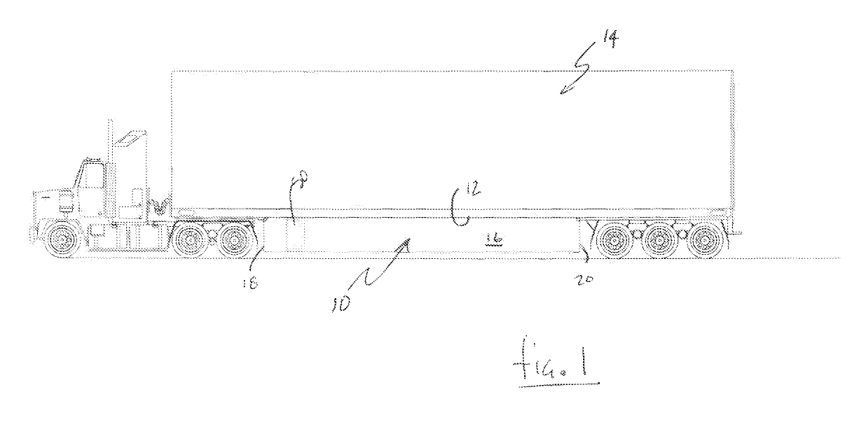

Now referring to the drawings, the fairing system is shown and generally illustrated in the figures. As can be seen at FIG. 1, the fairing system 10 is attachable to a lower, longitudinal edge 12 of a trailer 14, such as a commercial freight trailer, in a manner that alters the airflow beneath and around the trailer to produce increased fuel efficiency and greater driving safety.

Generally, in accordance with the present invention, the skirt fairing 10 is formed from a deformable skin material 16 that is stretched tautly over a deflectable frame which is attached to the lower outboard edge 12 of a trailer 14. The installation of the skirt fairing 10 deflects and alters the airflow beneath the trailer 14 by creating smooth and cohesive airflow along the side and underneath the trailer of a tractor trailer rig in a manner that improves safety and decreases fuel consumption. Further, the fairing system 10 of the present invention is formed using a deformable skin 16 and deflectable frame that prevents damage or permanent displacement of the fairing should it impact an obstruction. Further, if the skirt fairings are damaged they can be removed from the truck with a pocket knife, folded up and placed in the cab of the truck, very easily as compared to the other products that are available thereby allowing the truck to complete the delivery.

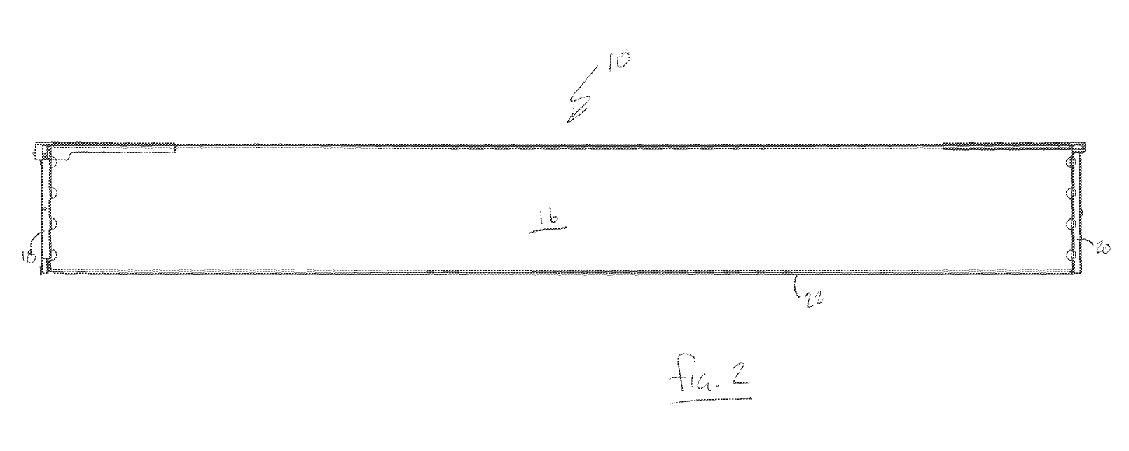

Turning now to FIG. 2, most generally the skirt fairing 10 of the present invention includes a deformable support frame structure and a skin 16 material stretched over the support frame. In the simplest embodiment the frame includes forward 18 and rearward 20 vertical rails that are affixed at the front and rear of the region to be covered along the longitudinal edge 12 of the trailer 14. The vertical rails 18, 20 are affixed using a hinge or spring that allows for temporary deformation of the rails when they come upon an obstruction, yet return to their original position without damage. A deformable skin 16 is then stretched tautly between the two vertical rails 18, 20.

To further enhance the functionality and durability of the skirt fairing, a bottom frame member 22 may be provided that extends between the lower ends of the forward 18 and rearward 20 vertical rails. The bottom frame member 22 may be joined or flexible tubing, a cable, rope, nylon webbing or a chain. In operation, the vertical rails 18, 20 are spring biased such that the lower ends of the vertical rails 18, 20 in an unrestrained state will flair apart from one another such that when the lower rail 22 or skin 16 is installed, the spring bias serves to tension the entire surface of the system. If a bottom rail member 22 is employed, the bottom edge of the skin 16 in this arrangement would then be affixed to or about the lower frame member 22 as well.

It should be appreciated by one skilled in the art that there are several means for mounting the vertical rails to allow for temporary deflection and biasing thereof. In one embodiment coil springs may be employed at the top ends thereof to allow deflection and induce biasing. Still further, flexible struts, spring loaded struts or gas shocks may be employed to urge the vertical rails apart from one another and to a vertical position relative to the ground yet also allow temporary deflection of the system when an obstruction is encountered. Further, such struts, shocks or springs may be used singularly or in multiples to bias the vertical frame rails in the desired directions.

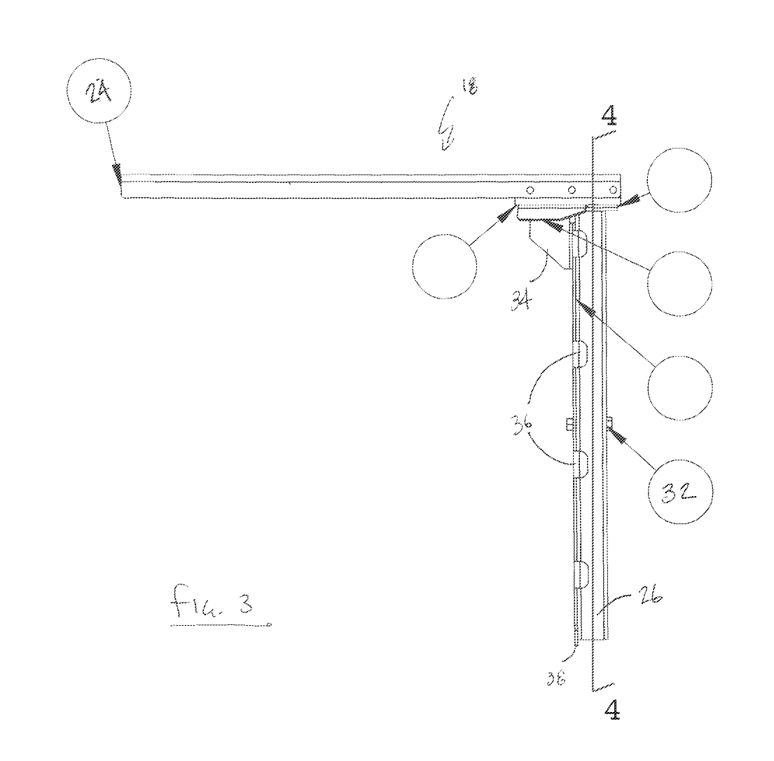

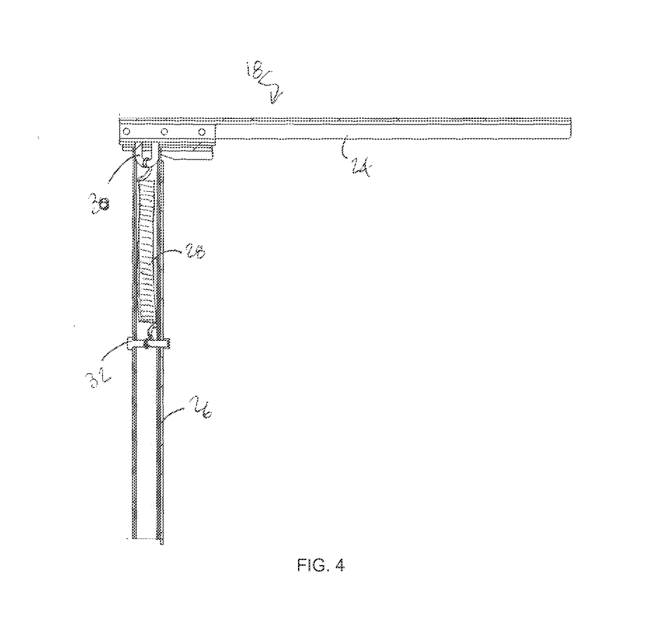

In the preferred embodiment as depicted at FIGS. 3-4, one of the vertical supports 18 can be seen. This support 18 is configured and arranged to allow displacement of the support in any direction. A top member 24 can be seen for mounting the vertical support 18 to the underside of the trailer. The vertical support 26 itself extends downwardly from the top member 14 and is affixed thereto by a coil spring 28. The coil spring 28 extends between a fastener 30 at the top member 24 and a through bolt 32 extending through the vertical support 26. In this arrangement, the tension of the coil spring 28 serves to maintain the vertical member is a substantially perpendicular, plumb position relative to the top member, yet allows sufficient freedom of motion should the fairing system encounter an obstacle that requires deflection. It can also be seen that a flange 34 is provided to add support and increase the torque required to displace the vertical support in an inward fashion. This allows the vertical support to maintain the fairing skin taught against the turbulent wind forces experienced when towing the trailer on the road yet still deform when sufficient force is applied.

Attachment points 36 can be seen distributed along the edge of the vertical support 26. The attachment points 36 are provided to receive and retain one edge of the fairing skin 16 in a reliable and secure manner. The skin 16 may be fastened by any method known in the art such as by lacing, through the use of a batten or even by grommets. One skilled in the art should appreciate that the skin may alternately include a pocket at the end thereof that is slidably received about the vertical support. Should a bottom frame member 22 be employed, an attachment point 38 can be seen provided at the terminal end of the vertical support. The bottom horizontal frame member, if used would attach here.

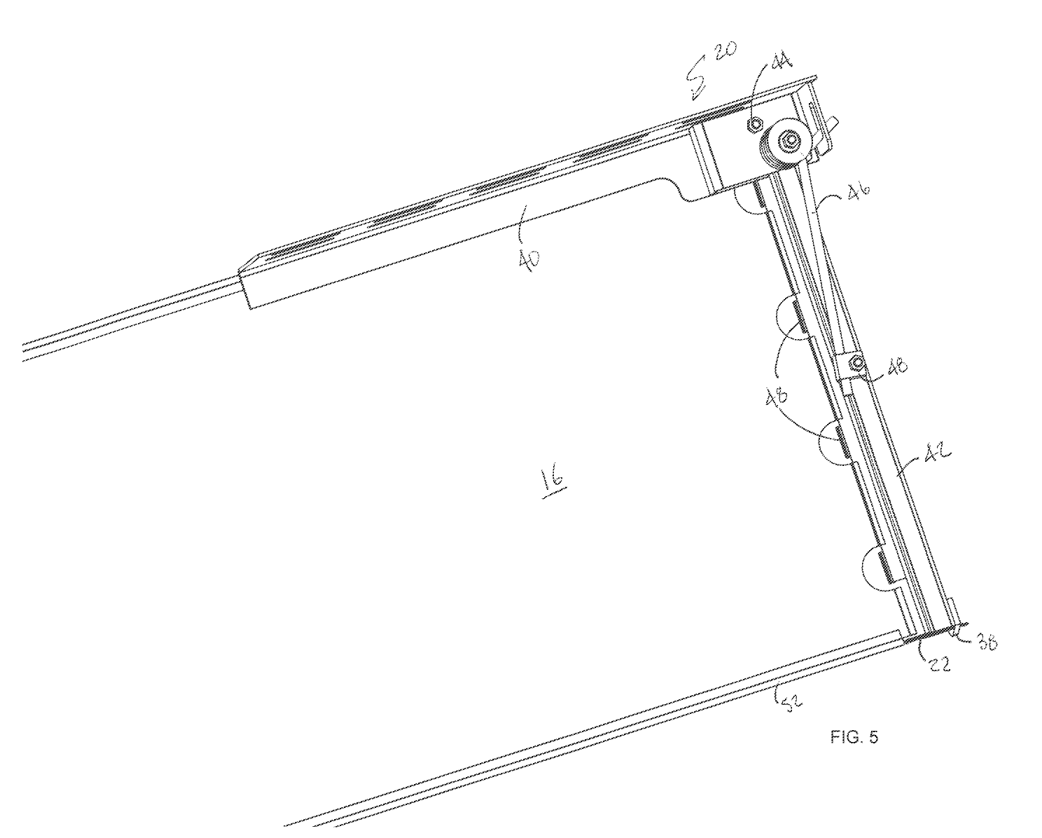

Turning now to FIG. 5, the other vertical support 20 is depicted. This support 20 is configured and arranged to allow displacement of the support in a two dimensional plane aligned with the plane of the fairing skin 16. A top member 40 can be seen for mounting the vertical support to the underside of the trailer. The vertical support 42 itself extends downwardly from the top member 40 and is affixed thereto by at a hinge point such as the bolt 44. A spring 46 can be seen extending between the top member 40 and an attachment point 48 on the vertical support 42. In this arrangement, the tension of the spring 46 serves to tension the vertical member against the plane of the skin creating a mechanism for keeping the skin stretched taught between the two vertical supports.

This vertical support also includes attachment points 48 that can be seen distributed along the edge of the vertical support. The attachment points 48 are provided to receive and retain one edge of the fairing skin 16 in a reliable manner. The skin may be fastened by any method known in the art such as by lacing, through the use of a batten or even by grommets. One skilled in the art should appreciate that the skin may alternately include a pocket at the end thereof that is slidably received about the vertical support. Should a bottom frame member 22 be employed, an attachment point 38 can be seen provided at the terminal end of the vertical support. The bottom horizontal frame member, if used would attach here.

The top edge of the skin is preferably affixed to the underside or outside lower edge of the trailer. The top edge may be affixed to the trailer by any method know suitable in the art. Such methods of affixing the skin may include lacing wherein the skin has grommets through which the lacing passes. Further a top frame member may be employed around which the skin is laced. The top frame member may also be an extrusion that captures and retains the top edge of the fairing skin that may further include a bolt rope hemmed into the top edge thereof. Still further the skin may be secured simply with a batten and periodic fasteners such as screws or bolts therethrough.

In the context of the present invention the deformable skin 16 that is disclosed may be a polymer sheet, a polymer textile, a polymer coated textile, or a similar material appreciated by one skilled in the art. Such skins are known in the context of billboards, canopies, truck traps and large tents. Access doors 50 as depicted at FIG. 1 may be provided in the skin material employing polymer zippers or other fastenable flaps such that the user can be allowed access to the trailer jack, utility connections and the like that are typically located beneath the trailer.

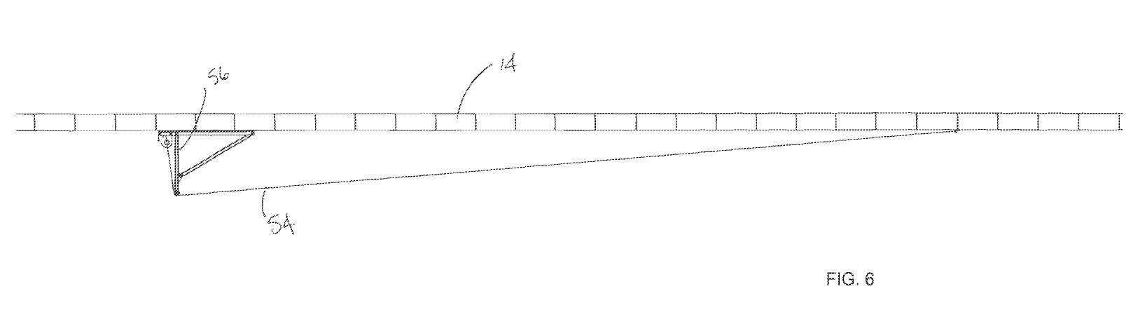

To prevent the skin from flapping or snapping along its unsupported central section, additional support may be provided. Such supports include hinged arms that extend down from the bottom of the trailer at periodic intervals along the length thereof. The hinged arms are preferably biased in an outward manner such that they exert pressure against the deformable skin to maintain it in a taut manner much like a sail. The hinged arms may employ coil springs at their top or may employ shocks, struts, flexible fiberglass rods or the like to create the outward bias against the skin. Still further, the arms may be bowed in a manner that insures good contact with the skin without creating hard spots or chafe points. Additionally, as seen in FIG. 6, a lower edge protection 52 may be installed to prevent the bottom edge of the skin 16 from being damaged, cut or overly worn resulting in premature failure of the system.

At FIG. 6 an additional skin panel 54 for use in connection with the system of the present invention is shown. The additional skin 54 is affixed to the underside of the trailer 14 at the forward end and then tapers down as it extends to the rear of the trailer. The additional skin 54 is supported on a frame 56 at its rear so as to form a rearwaredly facing wedge beneath the trailer 14. The wedge serves to smoothly guide airflow beneath the trailer thereby preventing turbulent flow that occurs due to the support ribs on the underside of the trailer floor. Further, the wedge breaks the airflow before it reaches the substantially vertical surface of the rear axles thereby improving airflow at this location as well.

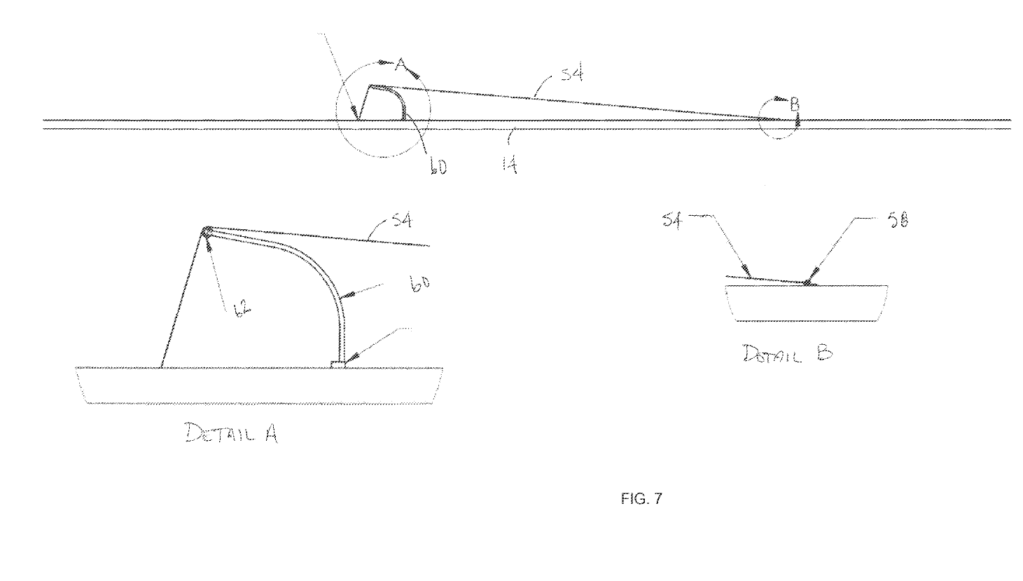

At FIG. 7, an alternate arrangement is shown for supporting additional skin panel 54 for use in connection with the system of the present invention is shown. The additional skin 54 is affixed to the underside of the trailer 14 as described above. At the forward end 58 the skirt may be retained by a clamp or in an extrusion that accepts a bolt rope affixed to the edge of the additional skin 54. The additional skin 54 is supported at on a flexible support 60 at its rear so as to form a rearwaredly facing wedge beneath the trailer 14. The flexible support 60 is mounted to the trailer 14 and includes a tube 62 extending longitudinally to uniformly distribute the force exerted by the flexible support and tension the additional skin 54.

It can therefore be seen that the present invention provides a trailer skirt that is flexible and resilient such that when the skirt impacts another object or obstruction the skirt will temporarily deform and then return to its original deployed position. It can also be seen that the present invention to provide a trailer skirt system that is formed using a flexible, inexpensive skin panel that is stretched taught over a resilient frame such that when the skirt impacts another object or obstruction the skirt will temporarily deform and then return to its original deployed position with little or no damage to the system. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A skirt system for a highway truck trailer comprising:
a first vertical support configured and arranged to be affixed to a lower peripheral edge of the truck trailer, said first vertical support being spring biased to a plumb position and displaceable upon application of a force thereto;
a second vertical support configured and arranged to be affixed to the lower peripheral edge of the truck trailer in spaced apart relation relative to said first vertical support, said second vertical support being spring biased away from said first vertical support and displaceable in a forward or rearward direction upon application of a force thereto; and
a resilient skin having a top edge configured to be secured to said lower peripheral edge of said truck trailer, said skin being received and supported between said first and second vertical supports, the spring bias of said second vertical support maintaining said skin taut.

2. The skirt system of claim 1, wherein said skin is made of a material selected from the group consisting of: polymer sheet, textile, and polymer coated textile.

3. The skirt system of claim 1, wherein said skin has pockets at front and rear edges thereof, said pockets being received and retained around said first and second vertical supports.

4. The skirt system of claim 1, wherein said first and second vertical supports include attachment points spaced along a length thereof, said skin being attached to said attachment points.

5. The skirt system of claim 1, further comprising:
a bottom frame member extending between terminal ends of said first and second vertical supports, the spring bias of said second vertical support maintaining said bottom frame member taut, wherein a bottom edge of said skin is fastened to said bottom frame member.

6. The skirt system of claim 1, further comprising:
a top frame member affixed proximate said lower peripheral edge of said trailer and extending between said first and second vertical supports, wherein a top edge of said skin is fastened to said top frame member.

7. The skirt system of claim 1, further comprising:
a vertical frame configured and arranged to be fastened transversely across a bottom surface of the truck trailer proximate a rear axle thereof; and
a second skin having a front edge configured and arranged to be fastened transversely across the bottom surface of the truck trailer and a rear edge that is supported by said vertical frame, said second skin covering a portion of said bottom surface of said truck trailer.

8. The skirt system of claim 7, wherein said second skin is made of a material selected from the group consisting of: polymer sheet, textile, and polymer coated textile.

9. A skirt system for a highway truck trailer having a bottom surface, a rear axle and a lower peripheral edge extending along an outboard edge of said bottom surface comprising:
a first vertical support affixed to the lower peripheral edge of said truck trailer, said first vertical support being spring biased to a plumb position and displaceable upon application of a force thereto;
a second vertical support affixed to the lower peripheral edge of said truck trailer in spaced apart relation relative to said first vertical support, said second vertical support being spring biased away from said first vertical support and displaceable in a forward or rearward direction upon application of a force thereto; and
a resilient skin having a top edge configured to be secured to said lower peripheral edge of said truck trailer, said skin being received and supported between said first and second vertical supports, said spring bias of said second vertical support maintaining said skin taut.

10. The skirt system of claim 9, wherein said skin is made of a material selected from the group consisting of: polymer sheet, textile, and polymer coated textile.

11. The skirt system of claim 9, wherein said skin has pockets at front and rear edges thereof, said pockets being received and retained around said first and second vertical supports.

12. The skirt system of claim 9, wherein said first and second vertical supports include attachment points spaced along a length thereof, said skin being attached to said attachment points.

13. The skirt system of claim 9, further comprising:
a bottom frame member extending between terminal ends of said first and second vertical supports, said spring bias of said second vertical support maintaining said bottom frame member taut, wherein a bottom edge of said skin is fastened to said bottom frame member.

14. The skirt system of claim 9, further comprising:
a top frame member affixed proximate said lower peripheral edge of said trailer and extending between said first and second vertical supports, wherein a top edge of said skin is fastened to said top frame member.

15. A skirt system for a highway truck trailer having a bottom surface, a rear axle, and a lower peripheral edge extending along an outboard edge of said bottom surface comprising:
a vertical frame configured and arranged to be fastened transversely across the bottom surface of the truck trailer proximate a rear axle thereof; and
a skin having a front edge configured and arranged to be fastened transversely across the bottom surface of the truck trailer and a rear edge that is supported by said vertical frame, said second skin covering a portion of said bottom surface of said truck trailer.

16. The skirt system of claim 15, wherein said skin is made of a material selected from the group consisting of: polymer sheet, textile, and polymer coated textile.

17. The skirt system of claim 15, further comprising:
a first vertical support affixed to the lower peripheral edge of said truck trailer, said first vertical support being spring biased to a plumb position and displaceable upon application of a force thereto;
a second vertical support affixed to the lower peripheral edge of said truck trailer in spaced apart relation relative to said first vertical support, said second vertical support being spring biased away from said first vertical support and displaceable in a forward or rearward direction upon application of a force thereto; and
a second resilient skin having a top edge configured to be secured to said lower peripheral edge of said truck trailer, said second skin being received and supported between said first and second vertical supports, said spring bias of said second vertical support maintaining said second skin taut.

18. The skirt system of claim 17, wherein said second skin is made of a material selected from the group consisting of: polymer sheet, textile, and polymer coated textile.
